(19) United States
(12) Patent Application Publication
(10) Pub. No.: US 2025/0013251 A1
(43) Pub. Date: Jan. 9, 2025

(54) VEHICLE SWARM CONTROL

(71) Applicant: Apium, Inc., Pasadena, CA (US)

(72) Inventors: Alan Nise, Dallas, TX (US); Tyler MacCready, Pasadena, CA (US)

(21) Appl. No.: 18/762,136

(22) Filed: Jul. 2, 2024

Related U.S. Application Data
(60) Provisional application No. 63/512,478, filed on Jul. 7, 2023.

(51) Int. Cl. G05D 1/698; B64U 10/14; B64U 101/60; G05D 1/229; G05D 1/656; G05D 1/695; G05D 109/25

(52) U.S. Cl. CPC G05D 1/6983; G05D 1/229; G05D 1/665; G05D 1/695; B64U 10/14; B64U 2101/60; B64U 2201/102; G05D 2109/254

(57) ABSTRACT

In accordance with an embodiment, a method of operating a vehicle within a vehicle swarm includes: receiving a sortie specification, the sortie specification specifying a desired behavior the vehicle swarm is to perform; obtaining a position identification within the vehicle swarm; and calculating a set of waypoints based on the received sortie specification and the position identification.

### CROSS-REFERENCE TO RELATED APPLICATIONS

This application claims the benefit under 35 U.S.C. §119(e) of U.S. Provisional Patent Application No. 63/512,478, filed on Jul. 7, 2023, which is incorporated herein by reference in its entirety for all purposes.

### GOVERNMENT INTERESTS

The invention described herein was made with government support under N0001423WX00457 awarded by the Office of Naval Research. The government has certain rights in the invention.

### TECHNICAL FIELD

The present invention relates generally to a system and method for vehicle swarm control.

### BACKGROUND

The surge in technology has seen the evolution and proliferation of autonomous vehicles, notably drones, due to their multifaceted applications that range from aerial photography and delivery services to environmental monitoring and defense operations.

One approach within this context is swarm robotics, a strategy where a large number of robots work in concert. The complexity in this setup arises from the interactions among the robots, rather than individual robot behavior. Deploying a swarm of drones presents advantages in scenarios demanding extensive coverage, such as comprehensive environmental surveys or expansive search and rescue operations.

Nevertheless, a substantial challenge resides in managing and synchronizing a large number of autonomous vehicles efficiently. Contemporary methods face several obstacles when it comes to dealing with the individual programming and overall control of these swarming units.

Certain existing methods operate with one central controller which is responsible for managing all drones. Such a setup, while seemingly direct, encounters considerable issues as the number of drones grows. The complexity of issuing instructions to an ever-expanding swarm becomes progressively time-consuming and convoluted.

Alternative methodologies provide drones with local information, for example, by separately programming each drone, which allows them to operate with reduced dependency on a central unit. However, this comes at the cost of exponentially increasing the time required to program each drone.

### SUMMARY

In accordance with an embodiment, a method of operating a vehicle within a vehicle swarm includes: receiving a sortie specification, the sortie specification specifying a desired behavior the vehicle swarm is to perform; obtaining a position identification within the vehicle swarm; and calculating a set of waypoints based on the received sortie specification and the position identification.

In accordance with another embodiment, a system configured to be coupled to a vehicle within a vehicle swarm includes: a processor; and a memory coupled to the processor with instructions stored thereon, wherein the instructions, when executed by the processor, enable the processor to perform the following steps: receiving a sortie specification, the sortie specification specifying a desired behavior the vehicle swarm is to perform, obtaining a position identification within the vehicle swarm, and calculating a set of waypoints based on the received sortie specification and the position identification.

In accordance with a further embodiment, a method of controlling a vehicle swarm, includes: receiving, from a user interface, a swarm request specifying a desired behavior for the vehicle swarm to perform; encoding the swarm request into a data structure specific to the desired behavior; loading the encoded data structure into a designated portion of a packet; and transmitting, via a radio, the packet including the encoded data structure to a plurality of vehicles in the vehicle swarm to enable each vehicle to calculate a set of waypoints based on the swarm request and a position identification assigned to each vehicle.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a block diagram illustrating a system for controlling a swarm of vehicles according to an embodiment;

FIG. 2 is a block diagram illustrating a system for controlling a swarm of vehicles using a sortie specification according to an embodiment;

FIG. 3 is an illustrative diagram showing the relationship between the descent path, the descent angle, and a line representing the altitude of the target;

FIG. 4 illustrates a vehicle descent graph showing the flight path a vehicle takes as it descends towards a target on the terrain according to an embodiment;

FIG. 5 illustrates a method for executing a sortie using a swarm of vehicles according to an embodiment;

FIG. 6 illustrates a state diagram of a process for assigning a Position-ID for vehicles within a sortie according to an embodiment;

FIGS. 7A and 7B are vector diagrams that illustrate the calculation of waypoints according to the Circle-Circle Recipe-ID according to an embodiment;

FIG. 8 illustrates an example of a multi-stage sequence for a swarm of vehicles according to an embodiment;

FIG. 9 illustrates a flow diagram of a method for controlling a vehicle within a swarm to traverse a sequence of waypoints according to an embodiment;

FIG. 10 illustrates a sequence diagram depicting the data flow and interactions between the user, tablet, bridge, and dongle components of the vehicle swarm control system according to an embodiment;

FIGS. 11A-11D depict scenarios related to vehicle spacing and collision avoidance when vehicles attempt to form a formation; and

FIG. 12 a block diagram of a processing system that can be used to implement embodiment systems and algorithms.

Corresponding numerals and symbols in different figures generally refer to corresponding parts unless otherwise indicated. The figures are drawn to clearly illustrate the relevant aspects of the preferred embodiments and are not necessarily drawn to scale. To more clearly illustrate certain embodiments, a letter indicating variations of the same structure, material, or process step may follow a figure number.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention and do not limit the scope of the invention.

Embodiments of the present invention are directed generally to autonomous drone swarms., and in particular to a control system that quickly and efficiently programs a group of swarming drones to fly in various patterns and sequences in a bandwidth efficient manner.

Particular applications are many and varied. For example, drone swarms may be coordinated to perform environmental measurements, perform in airshows and other exhibitions, and perform aerial surveillance and photography in support of rescue and other operations.

One prior drone swarming application allows multiple vehicles to be launched at once while following different pathways. With this algorithm, a comma separated values (CSV) file which contains a list of pathways is uploaded to ground station. As vehicles are brought into a designated launch area, the ground station assigns a pathway to each vehicle through a radio channel. After multiple vehicles have been brought into the launch area and have been assigned pathways, they are launched simultaneously after which the vehicles pursue their pathways while coordinating with the other vehicles in the swarm to avoid collisions.

One difficulty with this algorithm is the time and bandwidth needed to prepare and upload the pathway file to the ground stations, which, in some cases, prevents the vehicles from being re-tasked after launch. Additionally, preparation of CSV files is time consuming, often needs a laptop to prepare the CSV file, and is difficult to perform in the field or in in battle conditions.

In embodiments of the present invention, drones are quickly programed by providing a high-level description of one or more actions to be performed by the drone swarm. Upon receipt of the high-level description, each drone calculates its own sequence of pathways and/or waypoints and associated actions (if applicable). By having each individual drone derive its own pathways and/or waypoints, a large amount of bandwidth is advantageously saved and the need to prepare CSV files containing waypoints is eliminated. Moreover, drone swarm programming may be performed quickly and on-the-fly.

It should be understood that embodiments of the present disclosure could be used to control the operation of many different types of vehicles. For example, drones described herein could be described more generally as Unmanned Aerial Vehicles (UAVs) Unmanned Surface Vessels (USVs) and Unmanned Ground Vehicles (UGVs) and Unmanned Underwater Vehicles (UUVs). UAVs could be subdivided into Multi Rotor Drones, Fixed Wing Drones and Fixed Wing Hybrid VTOL (Vertical Take Off and Landing). Such drones may relate to consumer, hobbyist and commercial versions of these platforms as well as possible automation in manned vehicles. Alternative embodiments may also be directed to non-flying vehicles such as watercraft, automobile, spacecraft and the like.

In the present disclosure, various terminology may be used to describe aspects of the invention. The variable “Vehicle-ID” refers to a unique integer number assigned to each vehicle in a swarm, which is used to differentiate between vehicles and identify individual vehicles, typically through a configuration file. A “sortie” describes a group of vehicles assigned to a specific mission, while the variable “Sortie-ID” is a unique number assigned to each sortie for the duration of their mission, used to re-command or recall a mission in process. A “sortie specification” is a collection of parameters that generally describe the routing, actions, scaling, timing, and behavior that a swarm should exhibit on a mission. A “recipe” refers to a predefined algorithm representing a specific method to generate waypoints, determining the patterns, sequences, and actions that members of the swarm should exhibit, which can be modified through other parameters in the Sortie Specification to determine spacing, timing, orientation, and other aspects of the routes, patterns, and behaviors to be considered when generating the waypoints. A system may contain more than one selectable recipe. The variable “Position-ID” is a unique sequential number that differentiates vehicles within the same sortie and is used to identify the positions a vehicle will occupy in patterns and prestaging locations. In some embodiments, the numbering starts at 1, but the numbering could be different in other embodiments. The pre-stage location” is the location where pre-staging occurs. “pre-staging” refers to the act of vehicles pausing to assemble themselves into a pattern prior to proceeding to the target, with the pattern at the pre-stage location potentially being the same or different from the pattern used at the target location.

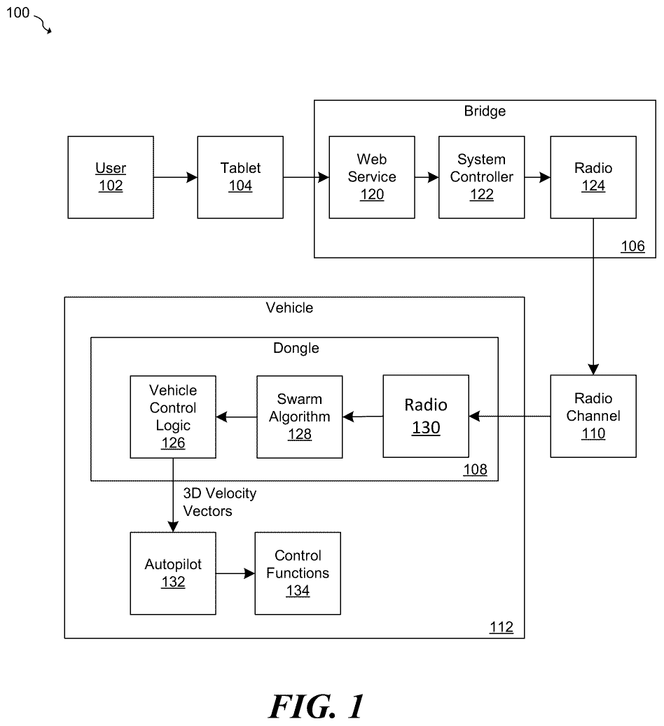

FIG. 1 is a block diagram illustrating a system 100 for controlling a swarm of vehicles 112 according to an embodiment. The system 100 includes a user 102, a tablet 104, a bridge 106, and a dongle 108 that is mounted on a vehicle 112. The tablet 104 provides a user interface between the user 102 and the bridge 106. The tablet 104 communicates with a web service 120 running on the bridge 106. The bridge 106 includes a system controller 122 that communicates with the dongle 108 via a radio 124. The dongle 108 includes circuitry implementing a swarm algorithm 128, a radio 130, and an interface to an autopilot 132 of the vehicle 112. Radio 124, radio channel 110 and radio 130 may form a radio frequency (RF) communication system. The vehicle 112 includes an autopilot 132 that controls the vehicle 112 based on commands received from the dongle 108. In some embodiments, autopilot 132 is configured to control various control functions 134 of vehicle 112, such as actuators that control flight control surfaces, motor controllers that control the speed and direction of motors and rotors, and the like.

The user 102 interacts with the tablet 104 to send commands and receive information about the swarm of vehicles 112. The user 102 may be a human operator, such as a pilot or a commander, who is responsible for controlling and monitoring the swarm of vehicles 112. The tablet 104 may be implemented using a tablet computer, such as an Android tablet or iPad. Alternatively, other computing equipment besides a tablet computer could be used for this function. The tablet 104 may run software that provides a map-based interface and allows the user 102 to send commands to the swarm. When a command is sent, the user 102 selects an algorithm and then is prompted to enter a series of parameters which are unique to each swarm algorithm.

The bridge 106 is a hardware device that acts as an interface between the tablet 104 and the swarm of vehicles 112. In one particular embodiment, the bridge 106 is a toaster-sized box that contains a single board Linux computer, a battery, and a radio. A WiFi hotspot is provided by bridge 106 to allow the tablet 104 to connect to the bridge 106. The bridge 106 runs a web application that provides a web interface the user 102 may use to configure and update the system 100. The web application also provides the Representational State Transfer (RESTful) interface used by the tablet application to interact with the swarm. The bridge 106 may also run a C++ program which does the actual interfacing with the swarm through the radio interface. The system controller 122 on the bridge 106 communicates with the dongle 108 via the radio 124.

The dongle 108 may be a small hardware module that contains an embedded processor and a radio 130 configured to be in communication with the bridge 106 and with other vehicles 112. The dongle 108 communicates with the bridge 106 and other vehicles 112 in the swarm through the on-board radio 130. The dongle 108 implements a variety of swarm algorithms using internal calculations and then interfaces with the vehicle's autopilot 132 where it queries information such as the vehicle's location and health while also commanding the vehicle's altitude, heading, and speed. In some embodiments, dongle 108 may communicate with other dongles within other vehicles within the swarm during operation. The swarm algorithm 128 is implemented on the dongle 108 that may include a processor and a memory (or other non-transitory computer readable medium) coupled to the processor. The memory may include a computer program that enables the processor to implement the vehicle control logic 126, swarm algorithm, as well as the embodiment methods described herein. Alternatively, swarm algorithm 128 may be implemented using one or more field programmable gate arrays (FPGAs), application specific integrated circuits (ASICs) and/or digital signal processors (DSPs) that implement the swarm algorithm.

In various embodiments, radio 124 and/or radio 130 may be implemented using a variety of wireless communication technologies and protocols. These radios can be designed to operate in different frequency bands and support various modulation schemes to enable reliable and efficient data transmission between the vehicles and the control system. Some common radio technologies that could be utilized include, but are not limited to Wi-Fi (IEEE 802.11), Bluetooth, cellular (4G/5G), LoRa, Zigbee, TCP-IP and UDP. In some embodiments, broadcast packets may be used. Wi-Fi radios operating in the 2.4 GHz or 5 GHz frequency bands can provide high-speed wireless connectivity over relatively short distances, making them suitable for inter-vehicle communication and data exchange with the control system when the vehicles are in close proximity. Bluetooth radios, particularly those supporting the Bluetooth Low Energy (BLE) standard, offer low power consumption and are well-suited for applications requiring frequent data updates and synchronization. Cellular radios, such as those compatible with 4G (LTE) or 5G networks, can enable long-range communication between the vehicles and the control system, leveraging existing cellular infrastructure to provide wide-area coverage and support high-bandwidth data transmission. LoRa radios are designed for low-power, long-range wireless communication, operating in sub-gigahertz frequency bands and achieving ranges of several kilometers, making them suitable for scenarios where the vehicles need to communicate over extended distances. Zigbee radios, based on the IEEE 802.15.4 standard, are known for their low power consumption and mesh networking capabilities, enabling the creation of self-healing, scalable networks among the vehicles for robust communication and data sharing.

The choice of radio technology depends on factors such as the desired communication range, data bandwidth requirements, power constraints, and the specific application scenario. The radios can be implemented using off-the-shelf modules or custom-designed radio boards that integrate the necessary components, such as transceivers, antennas, and microcontrollers. To ensure reliable and secure communication, the radios may incorporate various techniques, including encryption, error correction, and frequency hopping. Additionally, the radio firmware can be designed to support different network topologies, such as star, mesh, or hierarchical configurations, depending on the communication requirements of the vehicle swarm system. Ultimately, the selection and implementation of the radios will be based on a careful consideration of the system's overall architecture, performance goals, and operating environment, considering factors like range, data throughput, latency, and power efficiency.

The vehicle 112 is the physical entity that is being controlled as part of the swarm. The vehicle 112 may include a hull, airframe, motors, and servos. In some embodiments, the vehicle 112 may be, for example, an airplane, helicopter, quadcopter, or commercially available drone. In embodiments of the present invention, a drone swarm may include a plurality of vehicles 112 each in communication with its respective one of a corresponding plurality of respective dongles 108. In some embodiments, the vehicle 112 may be a non-flying vehicle such as an ground vehicle or watercraft. The vehicle 112 includes an autopilot 132 that controls the motion and behavior of the vehicle 112 based on commands received from the dongle 108. The autopilot 132 may be implemented using an embedded computer and may also include a GPS receiver, a gyro, and an accelerometer. In some embodiments, the autopilot 132 may be a commercially available autopilot system.

In an embodiment, a swarm system utilizes small packets, a portion of which is dedicated to holding requests for swarm commands and their associated parameters. In conventional implementations, in which waypoints are transmitted from the bridge to the dongle, each waypoint may take 8 bytes to store the latitude and longitude of the waypoint as well as more space to store any actions that would need to occur at those waypoints. Hence, in conventional embodiments, complex behaviors would implemented as their own complete algorithm, or are implemented by sending a list of waypoints to the vehicles.

In embodiments of the present invention, instead of sending a list of waypoints, a short specification representing the desired behavior of the drone swarm is sent. Each vehicle then decodes this specification, and generates its own list of waypoints based on this specification.

During operation, user 102 selects an algorithm, places a marker on the map at the desired target and enters associated parameters via tablet 104. The user 102 may then press a button (or provide activation via a GUI) to initiate transmission to bridge 106.

In response to the input of user 102, tablet 104 requests activation of the swarm algorithm by sending data as a JSON object to a specific REST endpoint using web service 120. This swarm request may include the algorithm selection and all parameters and target information as a list of values. In some embodiments, the swarm request may be a sortie specification as described herein, which may be entered by user 102, generated by tablet 104 based on the input of user 102 and/or generated by web service based on parameters provided by tablet 104. In alternative embodiments, the sortie specification may be generated using external software (not shown), such as an artificial intelligence (AI) process or external arbiter. The sortie specification may also be calculated by bridge 106 using internal automation.

Web service 120 then reformats the JSON object and forwards it to system controller 122 through a TCP Port. Next, system controller 122 receives the swarm request and encodes it into a data structure specific to the selected algorithm. The data structure is loaded into a designated portion of the main packet which is sent to the radio where it is transmitted over the radio channel 110 using radio 124.

Next, the packet is received by the radio 130 and decoded within the dongle 108. If the requested algorithm is not active, it is loaded and run. The algorithm specific data structure is extracted from the main packet and passed to the swarm algorithm 128. Finally, swarm algorithm 128 decodes the algorithm specific data structure and configures the algorithm.

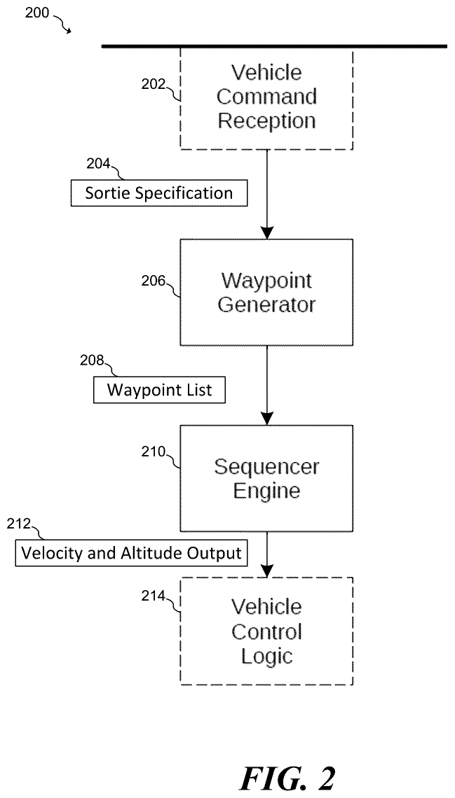

FIG. 2 is a block diagram illustrating a system 200 for controlling a swarm of vehicles using a sortie specification according to an embodiment. The system 200 includes a vehicle command reception component 202 that receives the sortie specification 204, a waypoint generator 206 that generates a waypoint list 208 based on the sortie specification 204, a sequencer engine 210 that processes the waypoint list 208 to generate velocity and altitude outputs 212, and a vehicle control logic 214 that translates the velocity and altitude outputs 212 into commands for the vehicle's autopilot.

The vehicle command reception component 202 is responsible for receiving radio packets and processing swarm commands. It receives the sortie specification 204, which is a series of parameters that collectively provide enough information to describe the behavior a group of vehicles should execute on a mission. The sortie specification 204 is transferred using the existing command portion of a swarm packet, making it bandwidth-efficient. The sortie specification 204 includes various fields such as Target Latitude and Target Longitude, Pattern Bearing, Recipe-ID, Velocity, Altitude, Spacing, Pre-Stage Distance, Descent Angle, Sortie-Size, Sortie-ID, Redirect (flag), and Volleys representing the number of volleys. These parameters define the high-level behavior of the swarm, including the target location, the shape of the formation, the speed and altitude of the vehicles, and the number of interactions with the target.

The waypoint generator 206 is a block of code that accepts the sortie specification 204 and translates it into waypoints and actions, which are placed on the waypoint list 208. The waypoint list 208 is a list populated and maintained internally by each vehicle, containing a series of geographic points in a particular order, along with any actions to be taken at those waypoints. The waypoint generator 206 uses the Recipe-ID specified in the sortie specification 204 to select a predefined algorithm for generating the waypoints. This algorithm determines the shape of the formation, the routes the vehicles will take to their final destinations, and any complex behaviors such as multiple visits to the target location or specific methods for changing altitudes along the way.

The sequencer engine 210 is a block of code that accepts the waypoint list 208 and uses the information contained in it to guide each vehicle from waypoint to waypoint while initiating any actions associated with each waypoint. The sequencer engine 210 can output either a 2-dimensional velocity vector indicating speed and direction on a plane parallel to the surface of the earth, along with an altitude, or a 3-dimensional velocity vector indicating the direction and speed of travel in 3D space.

The sequencer engine 210 may also include the ability to initiate altitude changes during a sortie, for example, by having the vehicle change altitude in place before proceeding to the current waypoint or by having the vehicle change altitude while in transit to the waypoint. There may, however, be situations where the vehicle descends to a target which is in an area constrained by obstructions in the flight path. This could be a location surrounded by towers, buildings or trees, or the target could be located in a deep canyon. If these obstructions exist beyond the pre-stage area, then the vehicle remains at a safe altitude until it has cleared the obstructions before descending to the target. The complexity of specifying this distance is compounded for patterns where vehicles could be approaching from all directions.

The vehicle control logic 214 is a system that interfaces with the vehicle's autopilot. It translates the velocity and altitude outputs 212 generated by the sequencer engine 210 into commands that are communicated to the vehicle's autopilot. The vehicle control logic 214 ensures that the vehicle executes the desired behavior based on the waypoints and actions specified in the waypoint list 208.

In an embodiment, the sortie specification 204 provides a high-level description of the desired behavior of the swarm. In one particular example, the sortie specification 204 includes fields as enumerated in Table 1:

TABLE 1
Sortie Specification

| Property | Type | Description |
|---|---|---|
| Target Latitude | 32 Bit Integer | The location of the target. |
| Target Longitude | 32 Bit Integer | |
| Pattern Bearing | integer | Rotation of the pattern or other aspect of the |
| | | generated waypoints as defined by a compass |
| | | bearing. This will affect different patterns differently. |
| | | For example, a pattern that assembles the vehicles |
| | | into a line will use this value to determine what |
| | | direction the line is facing. The bearing could also be |
| | | used to specify the pre-stage location or the approach |
| | | direction relative to the target. |
| Recipe-ID | Enumerated Type | Selection of the predefined algorithm used to |
| | | generate the waypoints This selection effects shape |
| | | that vehicles make when they reach their destination |
| | | as well as defines the behaviors and routes they will |
| | | take along the way to their final destinations. This |
| | | could include complex behaviors including making |
| | | multiple visits the target locations as well as the |
| | | methods vehicles use to change altitudes along the |
| | | way. |
| Velocity | unsigned integer | The maximum velocity that a vehicle should travel at |
| | | while traveling between waypoints. |
| Altitude | unsigned integer | The altitude that vehicles will go to during portions of |
| | | their flight. This may be used differently depending |
| | | on the pattern. |
| Spacing | unsigned integer | The inter-vehicle distance to use when assembling |
| | | vehicles into formations as defined by the selected |
| | | pattern. |
| Pre-Stage Distance | unsigned integer | Some recipes may define that the vehicles should |
| | | assemble in a preliminary formation a certain |
| | | distance before they get to the target. The parameter |
| | | defines that distance. This distance could be relative |
| | | to the target location, launch location, or another |
| | | arbitrary location depending on the selected Recipe. |
| Descent Angle | unsigned integer | For certain types of altitude changes, this is an angle |
| | | relative to the horizontal that the vehicle should use |
| | | to determine its descent vector. |
| Sortie-Size | unsigned integer | The number of vehicles that must be assigned to the |
| | | sortie. Only this number of vehicles will be assigned |
| | | to the sortie and any additional vehicles will not |
| | | participate or be launchable. |
| Sortie-ID | unsigned integer | A unique number assigned to the sortie. This is used |
| | | to address and redirect the sortie while it is in flight. |
| | | Multiple sorties may be in the air at once assuming |
| | | that they have unique Sortie-ID numbers. |
| Redirect | Enum | Defines whether the specification is defining a new |
| | | sortie or redirecting an existing sortie. |
| Volleys | Integer | Specifies the number of Volleys to occur within the |
| | | sortie. A volley constitutes a single interaction by a |
| | | vehicle with a target location. This interaction could |
| | | include actions such as taking a photograph or |
| | | dropping a payload. For certain patterns, multiple |
| | | volleys can be requested where a certain number of |
| | | vehicles would perform an action on the target |
| | | location, then after a fixed time delay, a similar |
| | | number of vehicles would return to the target to |
| | | perform the action again. A large number of volleys |
| | | could be executed by having only a portion of |
| | | vehicles proceed to the target at any one time. |

In an embodiment, sortie specification 204 is a data structure that contains various fields to define the behavior of a swarm of vehicles during a mission. The Target Latitude and Target Longitude fields, both represented as 32-bit integers, specify the precise geographic coordinates of the target location. The Pattern Bearing field, an integer, determines the rotation or orientation of the pattern or other aspects of the generated waypoints using a compass bearing. Its effect depends on the specific pattern being used, such as determining the direction of a line formation or specifying the pre-stage location or approach direction relative to the target.

The Recipe-ID field, an enumerated type, selects the predefined algorithm used to generate the waypoints. The chosen recipe affects the shape vehicles make when reaching their destination and defines their behaviors and routes, including complex behaviors like multiple visits to target locations and specific methods for changing altitudes. The Velocity field, an unsigned integer, specifies the maximum speed at which vehicles should travel between waypoints, while the Altitude field, also an unsigned integer, defines the altitude vehicles will maintain during portions of their flight, with its specific use varying depending on the chosen pattern.

The Spacing field, an unsigned integer, determines the inter-vehicle distance to maintain when forming patterns, and the Pre-Stage Distance field, another unsigned integer, defines the distance at which vehicles should assemble in a preliminary formation before reaching the target, relative to various locations depending on the recipe. The Descent Angle field, an unsigned integer, specifies the angle relative to the horizontal for determining the descent vector during certain altitude changes.

The Sortie-Size field, an unsigned integer, defines the exact number of vehicles to be assigned to the sortie, while the Sortie-ID field, also an unsigned integer, contains a unique identifier for addressing and redirecting the sortie in flight, allowing multiple sorties to be airborne simultaneously with distinct IDs. The Redirect field, an enumerated type, indicates whether the specification is defining a new sortie or redirecting an existing one.

Finally, the Volleys field, an integer, specifies the number of single interactions (such as taking a photograph or dropping a payload) that vehicles will have with the target location within the sortie. Multiple volleys can be requested for certain patterns, with groups of vehicles performing actions at the target followed by other groups after a fixed time delay, allowing a large number of volleys to be executed by having only a portion of vehicles proceed to the target at any one time.

It should be understood that the sortie specification of Table 1 above is just one of many possible examples. In alternative embodiments, greater, fewer and/or different parameters may be used depending on the particular embodiment and its specifications.

For the sortie specification 204, embodiment methods for specifying a safe point to start descent are advantageously data space efficient and intuitive for users to implement. Some embodiments of the present invention may be more bandwidth efficient, less resource intensive to implement, and/or provide a simplified user experience compared to other approaches that, for example, (1) specify a geographic shape that defines a safe zone for the altitude; (2) specify a distance from the target that vehicles can descend; or (3) specify an additional waypoint to define where a descent can start.

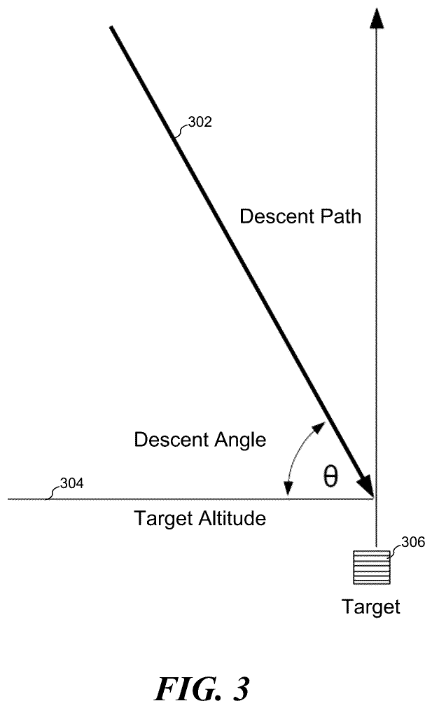

FIG. 3 is an illustrative diagram showing the relationship between the descent path 302, Descent Angle θ, and a line 304 representing the altitude of target 306. In various embodiments, line 304 is parallel to the ground in the x-y plane. As shown, the decent angle θ defines an angle θ from a line facing the direction of approach for the vehicle, to a line representing the path of approach.

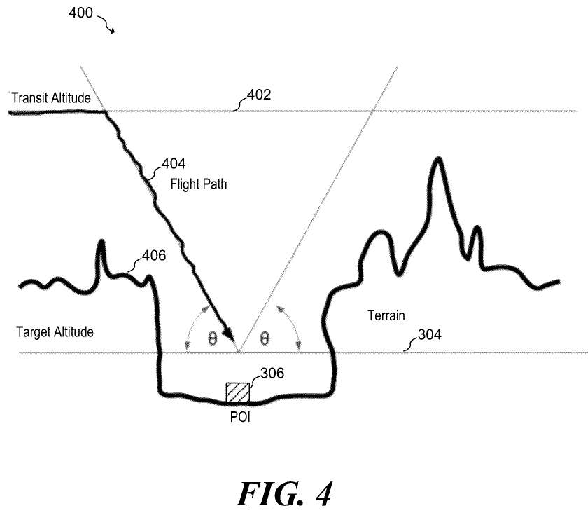

When rotated around a vertical axis extending through the target, Descent Angle θ defines a cone outside of which a vehicle on approach will not enter when descending to the target. Accordingly, a forward observer ordering a sortie could determine Descent Angle θ which a vehicle may safely descend to the target by estimation or measurement, as shown in FIG. 4, which illustrates vehicle descent graph 400, illustrating the flight path 404 a vehicle takes as it descends towards a target 306 on the terrain 406. In various embodiments, the decent angle θ is defined such that the flight path 404 does not intersect the terrain while descending to the target 306.

As shown, when approaching the target, the vehicle remains it its transit altitude 402 until it crosses the decent path at which time it will start its decent while attempting to stay on the decent path at Descent Angle θ.

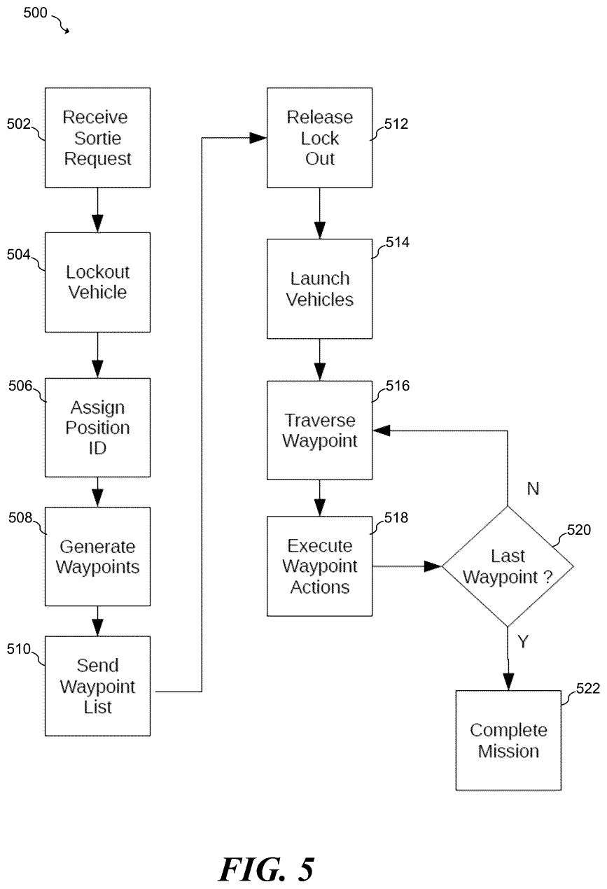

FIG. 5 illustrates a block diagram of a method 500 for executing a sortie using a swarm of vehicles. The process begins with the receive sortie request step 502, where a request to execute a sortie is received. Upon receiving the request, the method proceeds to the lockout vehicle step 504, in which the local vehicle is placed into a lock state. This lock state prevents the vehicle from being operated or accepting other sortie requests. In some embodiments, the lockout mode stays in effect during the arbitration and setup process until it is released in the release lockout state 512 described below.

Next, in the assign Position-ID step 506, the sortie assignment process is executed. This process determines whether the local vehicle is selected to be part of the sortie. If the local vehicle is selected, it will be assigned a Position-ID. If the local vehicle is not selected, the vehicle will wait for the next sortie request, which time the process will restart at step 502.

If the local vehicle is selected, the method moves to the generate waypoints step 508. Based on the assigned Position-ID and the selected recipe, the local vehicle calculates a series of waypoints and assigns actions to those waypoints. These waypoints and actions are then added to a waypoint list.

After the Position-ID is assigned to each vehicle during the assign Position-ID step 506, each vehicle calculates its own waypoints during the generate waypoints step 508 based on a sortie specification 204 that specifies a desired general behavior for the drone swarm, an assigned Position-ID for the current vehicle, and a reference to a waypoint list structure that the waypoint generator will populate.

In the send waypoint list step 510, the generated waypoint list is sent to the sequencer engine for further processing. After sending the waypoint list, the method proceeds to the release lockout step 512. In this step, the local vehicle is released from the lock state, after which it will be displayed on the tablet as ready to launch. The local vehicle, along with the other vehicles assigned to the sortie, will display a ready to launch status.

Once all vehicles are ready, the user will send a command to launch the vehicles in the launch vehicles step 514. After launching, the method enters the traverse waypoint step 516. In this step, the sequencer engine starts calculating 2-dimensional and 3-dimensional velocity vectors, which are continually sent to the autopilot. These vectors cause the vehicle to traverse the waypoints and change altitude as needed.

As the vehicle arrives at each waypoint, the method moves to the execute waypoint actions step 518. In this step, any actions assigned to the current waypoint will be executed. These actions can include altitude changes, waiting for other neighboring vehicles (e.g., other vehicles in the sortie) to arrive, waiting for fixed amounts of time, and executing payload drops.

After executing the waypoint actions, the method reaches a decision block 520 that determines whether the current waypoint is the last waypoint. If the current waypoint is the last waypoint, the method proceeds to the complete mission step 522. In this step, the vehicle will either land or return home by executing a landing algorithm, marking the completion of the sortie. If the current waypoint is not the last waypoint, the method returns to the traverse waypoint step 516, and the process continues until the last waypoint is reached.

In embodiments of the present invention, one or more processors within each vehicle (that may be housed, for example within the dongle 108), calculates its own set of waypoints (e.g. during the generate waypoints step 508) based on its Position-ID that was previously assigned during the Assign Position-ID step).

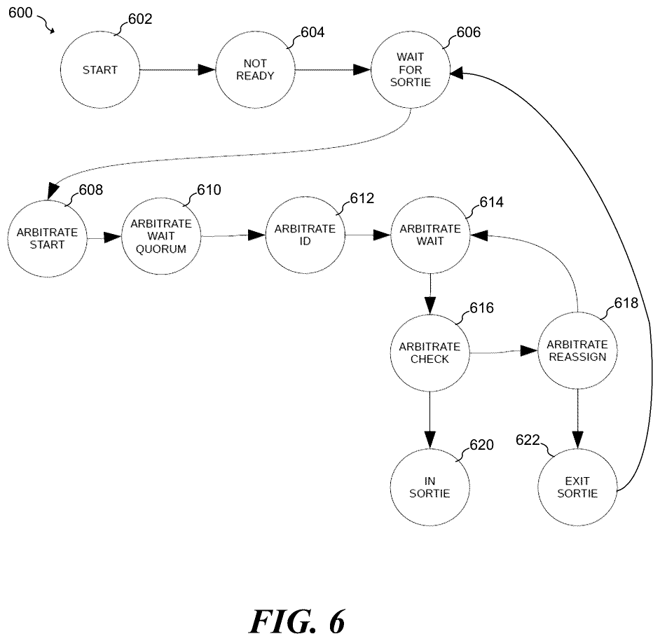

In an embodiment, the assign Position-ID step 506 may proceed according to the state diagram shown in FIG. 6, which illustrates a state diagram of a process for assigning a Position-ID to each vehicle in a vehicle swarm. The process begins in the START state 602, in which the state machine is initialized and prepared for operation.

Next, in the NOT_READY state 604, the vehicle waits until it is ready to be operated and has been brought into the launch area. Once ready, the vehicle transitions to the WAIT_FOR_SORTIE state 606 in which the vehicle waits for a sortie request command that includes the number of vehicles needed for the sortie (Sortie-Size). Upon receiving the sortie request command, the vehicle moves to the ARBITRATE_START state 608, which initializes data used for the arbitration process.

Next, the state machine immediately transitions to the ARBITRATE_WAIT_QUORUM state 610, in which the vehicle monitors incoming packets from other vehicles and waits until there are enough vehicles present and ready for launch to fulfill the requested Sortie-Size.

Next, in the ARBITRATE_ID state 612, the local vehicle assigns itself a Position-ID by counting the number of neighboring vehicles with a lower Vehicle-ID and adding 1 to that number. If the count of vehicles with a lower Vehicle-ID is greater than or equal to the Sortie-Size, the vehicle exits the sortie and returns to the WAIT_FOR_SORTIE state 606.

After assigning its Position-ID, the vehicle enters the ARBITRATE_WAIT state 614, waiting for a fixed amount of time to allow other vehicles to assign their Position-IDs and for those IDs to be transmitted and received.

In the ARBITRATE_CHECK state 616, the local vehicle verifies that no other vehicle in the swarm has assigned itself the same Position-ID. If no duplicate is found, the vehicle transitions to the IN_SORTIE state 620 in which the vehicle is now free to start executing the swarm algorithm with the other vehicles in the sortie. However, if a duplicate Position-ID is detected, the vehicle with the higher Vehicle-ID chooses a new Position-ID by finding the first unused number, as shown in the ARBITRATE_REASSIGN state 618. From the ARBITRATE_REASSIGN state 618, the vehicle can transition to the EXIT SORTIE state 622 or the ARBITRATE_WAIT state 614. In various embodiments, the vehicle transitions to the EXIT_SORTIE state 622 when it is determined that the vehicle is not a part of the sortie. This may occur, for example, if the vehicle lost arbitration and all slots in the sortie have been assigned. In some embodiments, the vehicle will then transition from the EXIT_SORTIE state 622 to the WAIT_FOR_SORTIE state 606. On the other hand, if it is determined that the vehicle is still a part of the sortie and a new position ID is assigned, the vehicle transitions from the ARBITRATE_REASSIGN state 618 to the ARBITRATE_WAIT state 614.

It should be understood that the state diagram of FIG. 6 is just one specific example of how the Position-ID is assigned to each vehicle in the swarm. In alternative embodiments, the arbitration process for determining the Position-ID may be based on other numbers besides Vehicle-ID, such as distance from a geographic point or distance from a chosen vehicle.

Referring back to FIG. 2, each Recipe-ID in sortie specification 204 is associated with a specified number of waypoints which each vehicle is designated to traverse. In particular, the Recipe-ID parameter of the sortie specification 204 specifies a recipe that has its own unique patterns, movements, actions and behaviors for the swarm to execute. In various embodiments, the sortie specification 204 includes additional parameters to modify how the selected recipe generates the waypoints. The waypoint generator 206 uses the unique Position-ID to calculate a location for each waypoint that is unique from the other vehicles in the sortie. Each waypoint's location may be calculated based on basic geometric shapes, or on more complex algorithms. The waypoint generator 206 cycles through each waypoint in order and, using the Position-ID as an input, calculates the waypoint for the local vehicle such that it has the right location relative to the other vehicles in the sortie. In some embodiments, the Recipe-ID is an index to a list that references predefined sequences of movements and behaviors to be implemented by the swarm. The Recipe-ID does not provide a description of the behaviors itself, rather the vehicles include internal data that defines these behaviors categorized by the Recipe-ID.

In an embodiment, one of the waypoints added is a designated pre-stage location where the waypoint location for each vehicle is arranged in a pattern that is either the same as that of the target location, or is a pattern that allows easy transition to the pattern used at the target location. Vehicles will remain at this pre-stage waypoint until all other vehicles in the sortie have arrived at their respective locations before proceeding to the target. In another embodiment, the spacing of the pattern at the pre-stage location is larger than the spacing at the target to allow vehicles ample room to negotiate their way their positions. Once the vehicles are in position at the pre-stage location, so long as the pre-stage pattern is chosen correctly, the vehicles will be able to maintain the same relative position on the way to target location, thus limiting the amount of maneuvering required and allowing the vehicles to transition to a pattern with a smaller inter-vehicle spacing.

After calculating the waypoint location, the waypoint generator 206 may assign actions to be taken at that waypoint. Alternatively, there may be waypoints where the vehicle does not perform any action. These actions may be included in behaviors indexed by the Recipe-ID parameter in some embodiments.

A general description of how waypoints are calculated from a Recipe is provided as follows.

Upon receipt of the sortie specification 204 the waypoint generator 206 calculates a series of waypoints and associated actions to fulfill the sortie specification. The waypoint generator 206 may support multiple behaviors such that each value of the Recipe-ID parameter defines a unique set of shapes and sequences to be exhibited by the vehicles during a sortie.

Table 2 provides a non-exclusive list of behaviors that could be supported by the system. It should be understood that while descriptive labels have been used herein to identify recipe parameter values, some embodiments of the present invention could encode the parameter values in any manner including any kind of numeric or alphanumeric index.

TABLE 2

| Recipe-ID Parameter | |
|---|---|
| Value | Description |
| Circle-Bunch | Vehicles form a circle several hundred meters around the |
| | target and then contract into a bunch over the target. |
| Circle-Line | Vehicles form a circle several hundred meters around the |
| | target and then contract to form a line originating at the target |
| | and then extending from the target at a specified bearing and |
| | separation. |
| Multi Stage | Vehicles preassemble at a specified distance before the target |
| | and then travel to the target where they will drop a payload, |
| | the vehicles then travel away to a location away from the target |
| | and after a minute, return to the target to drop another |
| | payload. |
| Circle-Circle | Vehicles form a circle several hundred meters around the |
| | target and then contract to a smaller circle around the target |
| | such that the vehicles are a specified spacing from each other. |

As mentioned above, each vehicle generates its own waypoints based on its Position-ID and the sortie specification 204. These waypoints can be used, for example, to determine a predefined route sequence. In one example, these waypoints can be calculated as follows with respect to the Circle-Circle Recipe-ID in which the vehicles form a circle around the target and then, once all vehicles have entered their pre-stage position, the swarm will proceed to converge onto a much smaller circle where they will drop a payload and return home. During the transition to the closer spacing, alternative parameters pertaining to allowable spacing during collision avoidance calculations may be used. While the Circle-Circle Recipe-ID is discussed as an example, it should be understood that in alternative embodiments, other behaviors may be possible, including, but not limited to V-formations, bunch formations, and line formations.

In some embodiments, the vehicle spacing is has a wide spacing during travel and then compresses to a smaller spacing while in formation in the vicinity of the target. For example, the vehicles may arrive at the target location with a nominal spacing. After arrival, the spacing between the vehicles can be compressed to be below the nominal spacing. In some embodiments, this change in vehicle spacing may be implemented by having the recipe generate an additional set of waypoints that define the positions of each vehicle at the closer spacing. In some embodiments, the ability to use this closer than nominally spacing may be enabled or disabled via a configuration file. It should be understood that this concept of compressed spacing after arrival at the target location is not limited to the Circle-Circle Recipe-ID and may be applied to any suitable Recipe-ID depending on the particular embodiment and its specifications.

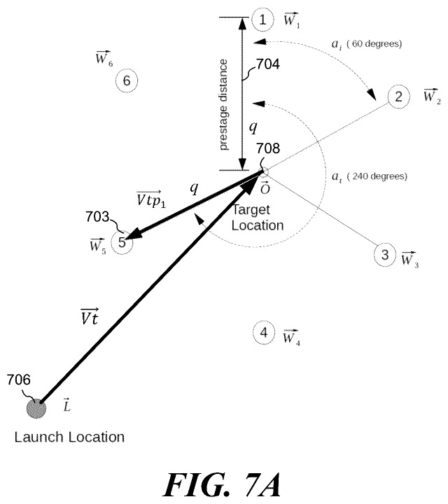

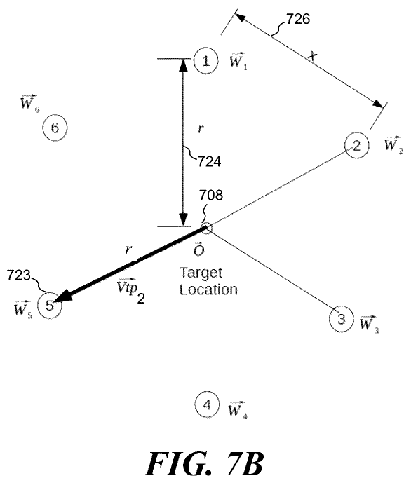

FIGS. 7A and 7B are vector diagrams that illustrate the calculation of waypoints according to embodiments of the present invention for the Circle-Circle Recipe-ID in which the, the waypoint list is populated with two waypoints: a first waypoint 703 shown in FIG. 7A whose position is calculated based on a known target location 708, pre-stage radius 704, and Position-ID, and a second waypoint 723 shown in FIG. 7B whose position is calculated based on the known target location 708, inter-vehicle spacing 726, and Position-ID.

As shown in FIG. 7A, the first waypoint 703 is located on a circle centered at the target location 708, with a radius 704 equal to the variable Pre-Stage Distance. During operation, a vehicle starting from launch location 706 arrives at first waypoint 703 is positioned on this circle along with its neighbors, evenly spaced around the circumference. At this first waypoint, the vehicle waits for its neighbors to arrive before proceeding to the next waypoint.

In some embodiments first waypoint 703 may be calculated by the vehicle based on the sortie specification. Intermediate waypoints may be included between launch location 706 and the first waypoint 703 to form a route between launch location and the first waypoint. These intermediate waypoints may define a corridor along with the vehicle swarm is to travel to a prestaging area. These intermediate waypoints may be calculated by each vehicle according to the sortie specification or may be explicitly transmitted to each vehicle. In such embodiments, the remaining waypoints are calculated thereafter by each vehicle according to the sortie specification with respect vehicle behavior after arrival at the prestaging area. The use of these intermediate waypoints is not limited to the Circle-Circle Recipe-ID and may be applied to any suitable Recipe-ID depending on the particular embodiment and its specifications.

In an embodiment, the only specific geographic location provided by the sortie specification is, for example, the latitude and longitude of a reference location, such as the target location. Alternatively, other coordinate systems or other reference locations may be used. In order to determine the coordinates of any waypoint, the system first calculates a vector \vec{W} which extends from the target location to the desired location of any waypoint. The system may then perform a calculation where the target location is offset by vector \vec{W} resulting in the latitude and longitude of the desired waypoint. This offset calculation may be performed using the standard great circle calculation method or a comparable computational method. FIGS. 7A and 7B each illustrate five waypoints corresponding to five vehicles, where each is offset by a respective corresponding vector \vec{W}₁, \vec{W}₂, \vec{W}₃, \vec{W}₄, \vec{W}₅.

In an embodiment, for the first waypoint, a vector \vec{Vtp}₁ representing a vector from target location 708 to the first waypoint 703 has a magnitude q and a target angle aᵢ. Note that first waypoint 703 for the fifth vehicle is shown for simplicity of illustration with respect to vector \vec{Vtp}₁, but the principle applies to all first waypoints for all corresponding vehicles at corresponding vectors \vec{W}₁, \vec{W}₂, \vec{W}₃, \vec{W}₄, \vec{W}₅. Magnitude q is the radius 704 of the circle (corresponding to the variable Pre-Stage Distance for the first waypoint), and target angle aₜ can be calculated according to:

$${a}_{t} = ( p - 1 ) {a}_{i} ,$$

where p is the Position-ID and aᵢ is the angular distance between vehicles according to:

$${a}_{i} = \frac{360}{s} ,$$

where s is the Sortie-Size. A vector from launch location 706 to first waypoint 703 can be calculated by summing vector \vec{Vtp}₁ with a vector \vec{Vt} representing vector from launch location 706 to target location 708. Note that in FIG. 7A, vector \vec{Vtp}₁ corresponds to each of vectors \vec{W}₁, \vec{W}₂, \vec{W}₃, \vec{W}₄, \vec{W}₅ for different corresponding angles aᵢ. In alternative embodiments, the first waypoint 703 may be determined based on an angle and distance relative to launch location 706.

As shown in FIG. 7B, the second waypoint 723 is also located on a circle centered at the target location, but with a radius 724 that ensures the vehicles are evenly spaced around the circle, maintaining a spacing distance from one another. Once the vehicle reaches the second waypoint 723, it performs the action of dropping its payload.

For the second waypoint, the vehicles form a circle of a different radius 724 around the target. For the second waypoint, a vector \vec{Vtp}₂ representing a vector from target location 708 to second waypoint 723 has a magnitude r and the target angle aᵢ. Magnitude r is the radius 724 of the circle, which can be calculated according to:

$$r = \frac{x}{2 sin ( \frac{180}{s} )}$$

where x is desired spacing between neighboring vehicles. Note that in FIG. 7B, vector \vec{Vtp}₂ corresponds to each of vectors \vec{W}₁, \vec{W}₂, \vec{W}₃, \vec{W}₄, \vec{W}₅ for different corresponding angles aᵢ. It should be understood that other patterns and sequences of behaviors could be supported by embodiment systems, for example, there could be other patterns or combinations of patterns, more complex routing, actions taken en-route to a destination, or an alternative approach to pre-staging. In some embodiments, a multi-state algorithm could be used by the sequencing engine to create behaviors more complex than simple two stage sorties. For example, a multi-stage algorithm can be created that allows vehicles to take multiple actions in an operational area. In between these actions, the vehicles could retreat to a waiting location outside of the operational area only to reappear for another action.

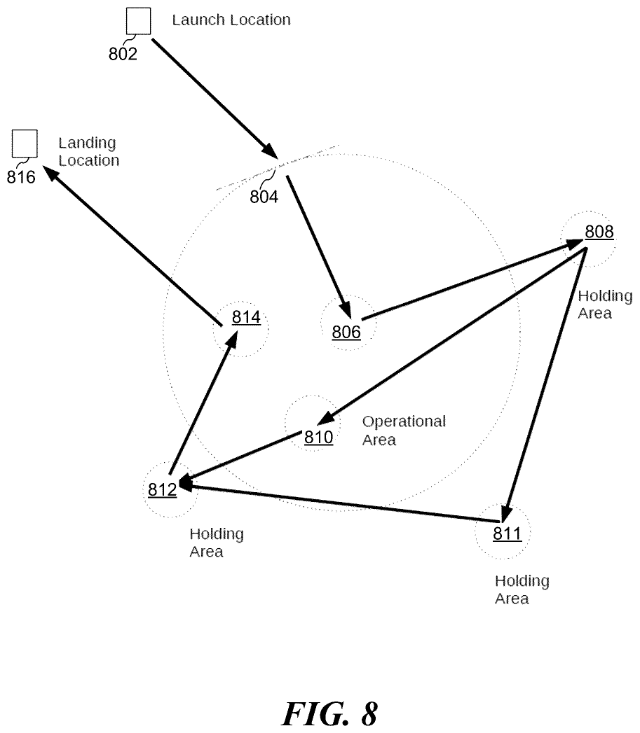

An example of such a multi-stage sequence is shown in FIG. 8, which illustrates an example of a multi-stage sequence for a swarm of vehicles. The sequence begins with the vehicles at location 802, which represents the launch area. The vehicles then move to location 804, where they assemble at the first waypoint in a line abreast formation.

Next, the vehicles proceed to location 806, which is the first location within the operational area. Here, they trigger an action. After completing the action, the vehicles move to location 808, exiting the operational area and entering the first holding area. From location 808, the swarm splits into two groups. A portion of the vehicles proceeds to location 810, which is a second location within the operational area, while the remaining vehicles bypass the operational area and head directly to location 811, which serves as a second holding area.

All vehicles then congregate at location 812, which is a third holding area. From there, the entire swarm proceeds to location 814, a third location within the operational area, where they trigger another action. Finally, the vehicles conclude the mission by triggering a separate landing algorithm that brings the swarm to the ground at the specified landing location, represented by location 816. This multi-stage sequence demonstrates the flexibility and adaptability of the swarm, allowing for complex behaviors and strategic splitting of the swarm to accomplish multiple objectives within the operational area, while also utilizing holding areas to regroup and coordinate the vehicles' actions.

In various embodiments, each step in the above multi-stage sequence could be implemented by providing a sortie specification to each vehicle (or to each dongle coupled to each vehicle). Each step could be implemented by having the waypoint generator on each vehicle create waypoint list entries for locations 804, 806, 808, (810 or 811), 812 and 814 on the diagram above and specifying the relevant actions for these waypoints after considering the local vehicle's assigned Position-ID. The manner of assignment would be the same as described in elsewhere herein for the simpler sequences, with the exception that there would be a larger number of waypoints in the list and, in the case of location 810, the location chosen based on the Position-ID would fall into 2 distinct groupings.

It should be further understood that FIG. 8 presents just one possible example of a multi-stage sequence for a swarm of vehicles, and that other specific multi-stage sequences could be tailored to specific mission requirements and operational scenarios.

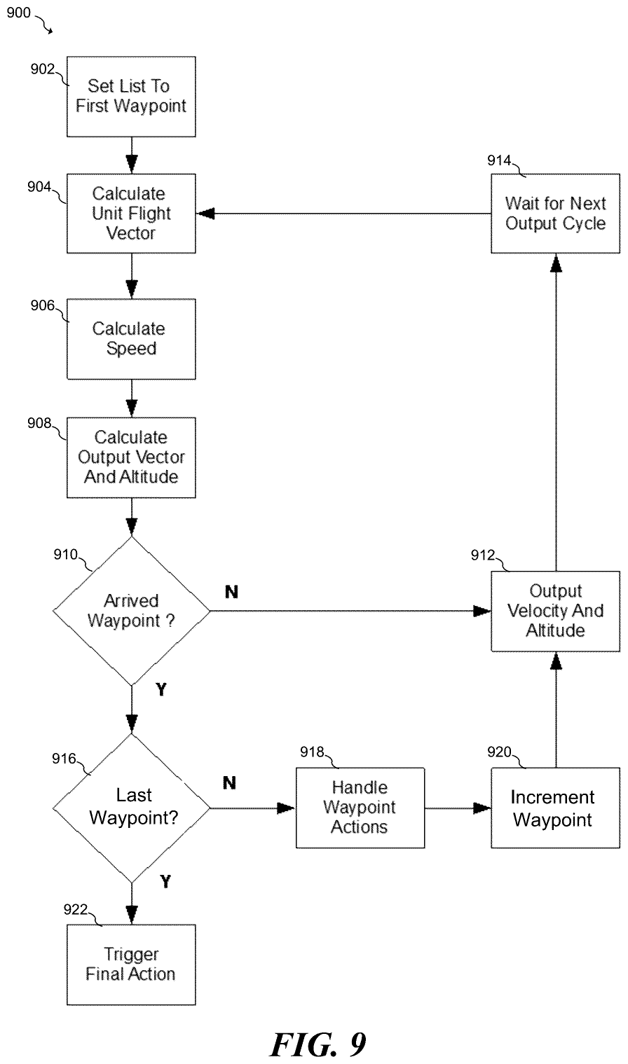

In an embodiment, once each vehicle has calculated its waypoints, a sortie can be initiated in which each vehicle travels to each waypoint and performs the actions specified for each waypoint (if applicable). In an embodiment, this operation is performed by a waypoint sequencer configured to perform the steps detailed in FIG. 9, which illustrates a flow diagram of a method 900 for controlling a vehicle within a swarm to traverse a sequence of waypoints. The method begins at step 902, where the waypoint list index is initialized to the first waypoint. In step 904, a unit flight vector is calculated from the vehicle's current location to the position of the current waypoint, with its magnitude normalized to one.

The vehicle's speed is then determined in step 906 based on three factors: the maximum speed specified in the sortie specification, the proximity to the next waypoint, and the proximity to neighboring vehicles. In step 908, a two-dimensional output vector is generated by scaling the unit flight vector by the calculated speed. Depending on the selected altitude mode for the current waypoint, this vector may be appended with an altitude value or extended to a three-dimensional velocity vector to guide the vehicle along a three-dimensional path to the waypoint.

Step 910 checks if the vehicle has arrived at the current waypoint, which is determined by evaluating if the vehicle is within a specified distance from the waypoint. If the vehicle has not arrived, the method proceeds to step 912, where the calculated velocity and altitude data are output to the vehicle control logic. Step 914 introduces a waiting period corresponding to the rate at which the vehicle control logic sends flight vectors to the autopilot. After the wait, the method returns to step 904 to recalculate the flight vector based on the updated vehicle position.

If the vehicle has arrived at the current waypoint, the method moves to step 916 to determine if the current waypoint is the last one in the list. If it is not the last waypoint, step 918 handles the execution of pre-programmed actions associated with each waypoint, such as hovering or delivering payloads. Next, step 920 increments the waypoint list index to point to the next waypoint, and the method returns to step 912 to calculate the flight vector for the new waypoint.

If the current waypoint is the last one, the method proceeds to step 922, where a final action is triggered. This action may involve landing the vehicle or initiating a return-to-home algorithm that guides the vehicle to a designated landing area while avoiding collisions with other vehicles.

The method 900 continues iteratively until all waypoints have been traversed and the final action has been triggered, ensuring that the vehicle navigates through the designated sequence of waypoints and performs requested actions at each location.

It should be appreciated that method 900 presented in FIG. 9 is just one example among many possible methods for controlling a vehicle within a swarm to navigate through a series of waypoints. The specific steps and their order can be adapted and modified based on the particular requirements and constraints of the vehicle swarm system. Furthermore, some of the steps in method 900 may be performed concurrently or in a different sequence, depending on the capabilities of the vehicle and the overall system architecture.

In an embodiment, during the sortie assignment process, vehicles exchange specific data to ensure proper coordination and avoid conflicts within the swarm. Table 3 outlines the information shared between vehicles. The “Sortie-ID” is a 4-bit unsigned integer that allows multiple sorties to operate simultaneously, prevents commands intended for one group of vehicles from affecting another group of vehicles, and allows multiple independently controlled missions to be in the air at the same time. The “Position-ID” also a 4-bit unsigned integer, enables vehicles to evaluate the assigned positions of their neighbors and detect any duplication of their own Position-ID. By exchanging these pieces of data, the vehicles can efficiently organize themselves into the designated sorties and maintain a coherent formation throughout the mission. While the “Sortie-ID” and “Position-ID” as specified as being 4-bit unsigned integers, other formats could be used depending on the requirements of the particular embodiment and its system implementations.

TABLE 3

| Name | Type | Description |
|---|---|---|
| Sortie-ID | 4-bit unsigned | Used to ignore vehicles that have |
| | integer | already been assigned to other sorties. |
| Position-ID | 4-bit unsigned | Used to evaluate what position-IDs |
| | integer | other neighbors have and detect |
| | | whether a vehicle has duplicated |
| | | another vehicle's position-ID. |

Table 4 presents a set of altitude actions that can be associated with waypoints in an embodiment of the system. These actions dictate how the vehicle adjusts its altitude when approaching or reaching a specific waypoint. The “NO_CHANGE” action maintains the vehicle's current altitude control strategy, ensuring a smooth transition between waypoints. The “PAUSE_TO_TRANSIT” action instructs the vehicle to halt its horizontal movement and ascend or descend to the designated transit altitude before proceeding to the next waypoint. The “GLIDE_TO_TRANSIT” action allows the vehicle to simultaneously adjust its altitude and continue its horizontal progress towards the next waypoint, providing a more efficient trajectory. The “PAUSE_TO_OPERATIONAL” action brings the vehicle to a specific operational altitude determined by the algorithm while maintaining zero horizontal velocity until the altitude is reached. The “GLIDE_TO_OPERATIONAL” action combines the altitude change with the horizontal movement, allowing the vehicle to reach the operational altitude gradually as it moves to the next waypoint. The “ANGLE_TO_OPERATIONAL” action instructs the vehicle to approach the next waypoint at a predefined angle of descent, maintaining the transit altitude until the descent path intersects with the vehicle's trajectory, and the “VECTOR_TO_OPERATIONAL” action instructs the vehicle to head along a 3D vector that points directly at the target such that the vehicles reach its final altitude at the same time it reaches the target. Finally, the “DISTANCE_TO_OPERATIONAL” action instructs the vehicle to wait until it is a specified distance from the waypoint before starting its decent. It should be noted that the actions listed in Table 4 are not exhaustive, and additional altitude control strategies can be implemented based on the specific requirements of the mission.

TABLE 4

| Action | Description |
|---|---|
| NO_CHANGE | There is no change in altitude control for this |
| | waypoint. The vehicle will continue doing what it |
| | already had been. |
| PAUSE_TO_TRANSIT | The vehicle will transition to the transit altitude |
| | while holding zero velocity. Once it reaches the |
| | transit altitude it will continue on to its next |
| | waypoint. |
| GLIDE_TO_TRANSIT | The vehicle will transition to the transit altitude |
| | while continuing onto the next waypoint. There is no |
| | pause. |
| PAUSE_TO_OPERATIONAL | Vehicle will transition to its algorithm specific |
| | operational altitude while holding o horizontal |
| | velocity. It will continue onto the next waypoint only |
| | after the altitude transition is complete. |
| GLIDE_TO_OPERATIONAL | Vehicle will transition to the operational altitude |
| | while continuing onto the next waypoint. There is no |
| | pause. |
| ANGLE_TO_OPERATIONAL | Vehicle will approach the next waypoint at a |
| | specified angle of descent. Vehicle will hold the |
| | transit altitude until the angle of descent intersects |
| | its path. |
| VECTOR_TO_OPERATIONAL | Similar to ANGLE_TO_OPERATIONAL except that |
| | the vehicle will head along a 3D vector that points |
| | directly at the target such that the vehicles will reach |
| | its final altitude at the same time that it reaches the |
| | target. |
| DISTANCE_TO_OPERATIONAL | Vehicle will wait until it is a specified distance from |
| | the waypoint before starting its decent. When decent |
| | starts, it will be in the manner of |
| | GLIDE_TO_OPERATIONAL |

Table 5 specifies a set of actions that vehicles can perform upon reaching designated waypoints in an embodiment of the system. These actions are used to coordinate the swarm's behavior and executing specific tasks at each waypoint. The “WAIT” action instructs the vehicle to hold its position at the current waypoint until the other vehicles have also reached their corresponding waypoint. This action ensures synchronization and maintains the cohesion of the swarm. The “HOLD: action introduces a fixed time delay at the waypoint, allowing the vehicle to pause for a predetermined duration before moving on to the next waypoint. This action may be used for tasks that require a specific timing or for coordinating sequential movements within the swarm. The “DROP” action triggers the release of a payload at the waypoint, enabling the vehicle to deliver supplies or perform other mission-specific tasks. These waypoint actions provide a flexible framework for defining the behavior of the vehicles at each stage of the mission. By combining these actions with the altitude control strategies from Table 4, the swarm can execute complex maneuvers and adapt to various operational scenarios. It should be noted that that the actions presented in Table 5 are representative examples, and the system can be extended to include additional actions based on the specific requirements of the mission or application.

TABLE 5

| Action | Description |
|---|---|
| WAIT | Vehicle waits until all neighbors have reached |
| | their corresponding waypoints before proceeding. |
| HOLD | Vehicle waits a fixed amount of time before proceeding. |
| DROP | Vehicle drops a payload at the waypoint. |

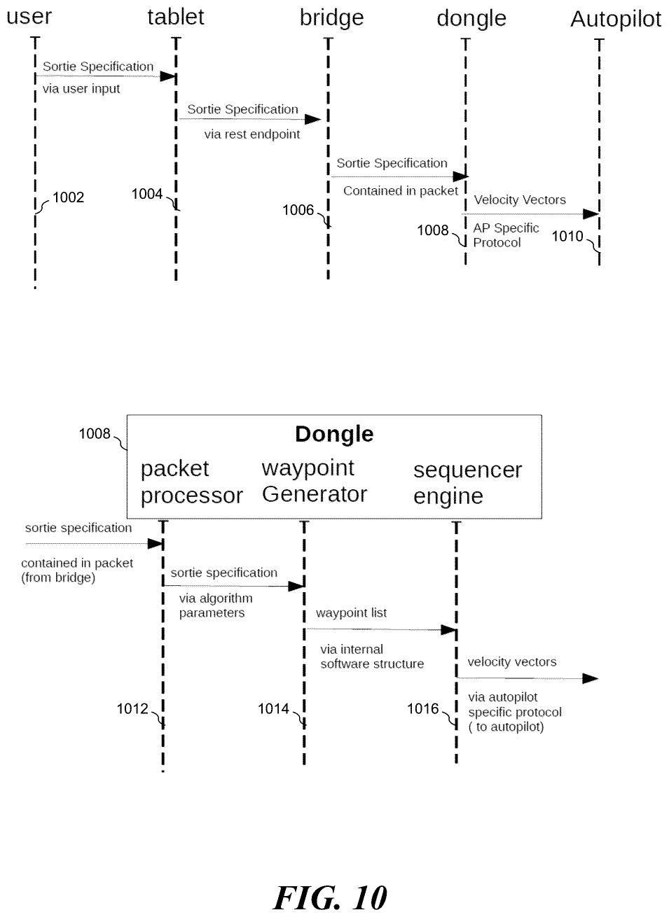

FIG. 10 illustrates a sequence diagram depicting the data flow and interactions between the user, tablet, bridge, and dongle components of the vehicle swarm control system, as well as the internal processing within the dongle, according to an embodiment. This sequence diagram represents one possible implementation of the system, highlighting the exchange of information and the order of operations.

The sequence starts with the user 1002 interacting with the tablet 1004 to input a sortie specification via the user interface. The tablet then sends the sortie specification to the bridge 1006 for further processing. Within the bridge, the sortie specification is encapsulated in a packet and transmitted to the dongle 1008 attached to each vehicle in the swarm. Next, dongle 1008 transmits information such as velocity vectors to autopilot 1010 within the vehicle.

Inside dongle 1008, the packet processor 1012 receives and extracts the sortie specification from the incoming packet. The extracted sortie specification is then passed to the waypoint generator 1014, which analyzes the specification and generates a list of waypoints based on the provided parameters (including the Recipe-ID) and the vehicle's assigned Position-ID.

Once the waypoint list is generated, it is forwarded to sequencer engine 1016, which manages the execution of the waypoints. Sequencer engine 1016 iterates through the waypoint list, determining the appropriate actions and altitude control strategies for each waypoint based on the information contained in the sortie specification and the vehicle's current state.

As the vehicle progresses through the waypoints, the sequencer engine 1016 sends commands, such as velocity vectors, to the vehicle's control system (e.g., autopilot 1010) to adjust the vehicle's velocity, altitude, and perform any specified actions at each waypoint. This process continues until all waypoints have been executed, and the vehicle completes its assigned tasks within the sortie.

The sequence diagram in FIG. 10 provides a high-level overview of the data flow and interactions between the various components of the vehicle swarm control system. The specific implementation details, such as the format of the sortie specification, the algorithms used by the waypoint generator, and the types of actions and altitude control strategies supported, may vary depending on the system's specifications and requirements. It should be noted that the sequence diagram of FIG. 10 is just one example of how the system can be structured and implemented. Different embodiments may include additional components, modify the order of operations, or incorporate alternative communication protocols and data formats to suit specific needs and constraints. It should be further understood that all or portions of the communication sequence shown in FIG. 10 may be performed before launching of the vehicles, after launching the vehicles, or a combination thereof.

Some embodiments of the present invention utilize pre-staging, which is the act of placing a set of waypoints before the target waypoints and having the vehicles wait at that location until all other vehicles in the sortie have reached that waypoint. Once all of the vehicles have reached the initial pre-stage waypoint, they will then proceed to the target waypoint. In some embodiments, pre-staging may be leveraged to allow vehicles to gather in formations at the target location with much smaller spacing then would be possible without pre-staging.

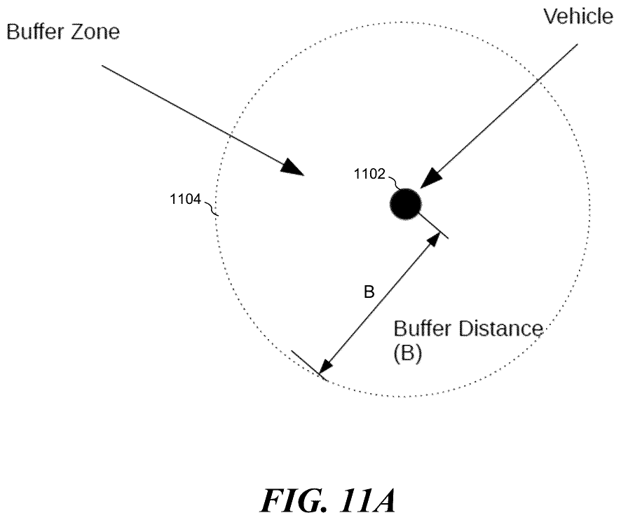

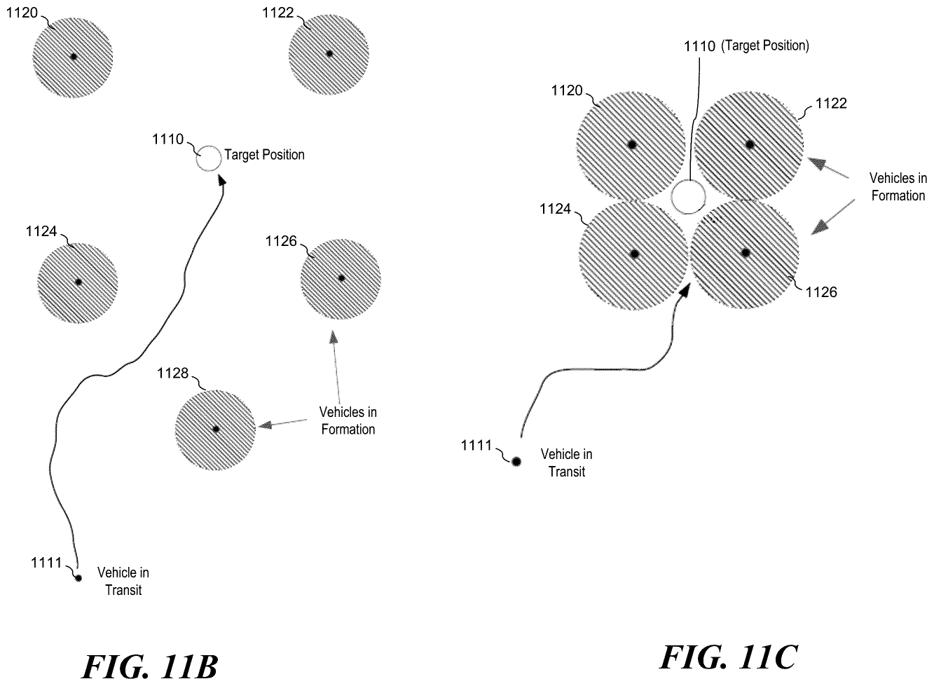

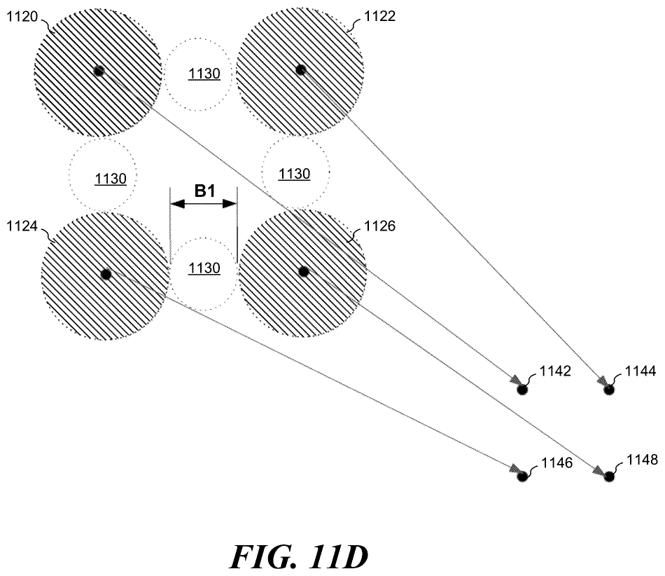

Some conventional systems use a collision avoidance technique where a multi stage buffer zone is defined around each vehicle. When one vehicle enters into another's buffer zone, evasive actions are taken. These evasive actions include changing the direction of travel (veering), slowing down, and, in cases where the vehicles get too close to each other, enter a special mode where they reverse their direction of travel in order to exit the other vehicle's buffer zone. An example of such a system is shown in FIG. 11A that illustrates a vehicle 1102 surrounded by a buffer zone 1104 having a buffer distance. B.

When attempting to have multiple vehicles arrange themselves into a formation or pattern, vehicles must be free to pass between one another in order to travel to their assigned position in a formation. As a formation is populated, vehicles that arrive to the formation position will need to pass between other vehicles that have already taken their position in the formation. If the spacing between vehicles is too small, there may arise a condition where a vehicle cannot pass between others in a formation without interacting with their buffer zones. During these interactions, the progress of a vehicle may be impeded as it interacts with the other vehicles buffer zones. This impediment could increase the amount of time required for a formation to be complete, or, in more extreme cases block vehicles from reaching their assigned positions altogether.

These situations are illustrated in FIGS. 11B and 11C, which demonstrate the challenges faced when vehicles attempt to form a formation with inadequate spacing.

FIG. 11B depicts a scenario where vehicles 1120, 1122, 1124, 1126 and 1128 (shown surrounded by their respective buffer zones). With sufficient spacing a vehicle in transit 1111 can approach target position 1110 without triggering collision avoidance maneuvers.

In contrast, FIG. 11C illustrates the problems that arise when vehicles attempt to form a formation with inadequate spacing. As the vehicles 1120, 1122, 1124, 1126 approach the formation, their respective buffer zones come close together. Accordingly, vehicle in transit 1111 is unable to approach target position 1110 without triggering collision avoidance actions, such as veering or slowing down. In extreme cases, vehicle in transit 1111 may find itself completely blocked by the buffer zones of other vehicles 1122 already in the formation. This can prevent the vehicle in transit 1111 from reaching its designated position altogether, leading to an incomplete or malformed formation.

In various embodiments, by using larger vehicle separation distances at the pre-stage location, vehicles can be given enough space to pass by one another when forming into their pattern. When the vehicles travel from the pre-stage location to the target location, the vehicles will already be in the proper position relative to each other and will maintain their relative positions as they travel to the target location. Because the vehicles do not need to move relative to each other, the large spacing previously needed to assemble at the pre-stage location is not required when traveling to the target location and thus formations with much smaller spacing may be used at the target location. Such a scenario is illustrated with respect to FIG. 11D that depicts vehicles 1120, 1122, 1124, 1126 initially forming a formation with an additional spacing 1130 between each vehicle having a length B1. This allows for additional vehicles to easily join the pre-stage location while reducing, minimizing or eliminating evasive measures taken upon approach of the additional vehicles. Once the vehicles have joined the pre-stage location, the vehicles 1120, 1122, 1124 and 1126 can approach respective target locations 1142, 1144, 1146 and 1148 with reduced spacings between each vehicle.

In further embodiments, to further improve system performance, special properties may be assigned to waypoints which disable some of the collision avoidance behaviors such as veering, on a per waypoint basis. Veering would remain active during most legs of the flight, including when forming at the pre-stage location. Veering could then be disabled when traveling between the pre-stage location and the target location, allowing vehicles to cross into each other's buffer area without impacting their flight path.

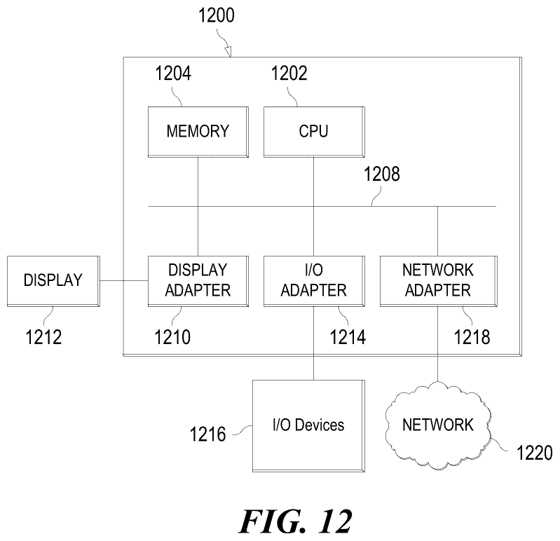

Referring now to FIG. 12, a block diagram of a processing system 1200 is provided in accordance with an embodiment of the present invention. The processing system 1200 depicts a general-purpose platform and the general components and functionality that may be used to implement portions of embodiments described herein such as the processing systems used to implement tablet 104, bridge 106, dongle 108 and/or vehicle 112. Processing system 1200 may include, for example, a central processing unit (CPU) 1202, and memory 1204 connected to a bus 1208, and may be configured to perform the processes discussed above according to program instructions stored in memory 1204 or on other non-transitory computer readable media. The processing system 1200 may further include, if desired or needed, a display adapter 1210 to provide connectivity to a local display 1212 and an input-output (I/O) adapter 1214 to provide an input/output interface for one or more input/output devices 1216, such as a mouse, a keyboard, flash drive or the like. The processing system 1200 may also include a network interface 1218, which may be implemented using a network adaptor configured to be coupled to a wired link, such as a network cable, USB interface, or the like, and/or a wireless/cellular link for communications with a network 1220. The network interface 1218 may also comprise a suitable receiver and transmitter for wireless communications. It should be noted that the processing system 1200 may include other components. For example, the processing system 1200 may include hardware components power supplies, cables, a motherboard, removable storage media, cases, and the like if implemented externally. These other components, although not shown, are considered part of the processing system 1200. In some embodiments, processing system 1200 may be implemented on a single monolithic semiconductor integrated circuit and/or on the same monolithic semiconductor integrated circuit as other disclosed system components.

Some embodiments of the present invention may utilize the systems and methods described in U.S. Pat. No. 10,372,143 which is incorporated herein by reference in its entirety.

Embodiments of the present invention are summarized here. Other embodiments can also be understood from the entirety of the specification and the claims filed herein.

Example 1. A method of operating a vehicle swarm, the method including: transmitting a sortie specification to each vehicle in the vehicle swarm, the sortie specification specifying a desired behavior the vehicle swarm is to perform; assigning a position identification to each vehicle in the vehicle swarm; and calculating, by each vehicle, a set of waypoints based on the transmitted sortie specification and the assigned position identification.

Example 2. The method of example 1, further including: each vehicle traversing its calculated waypoints.

Example 3. The method of one of examples 1 or 2, where the sortie specification includes a recipe identification parameter associated with a predefined route sequence.

Example 4. The method of example 3, where the recipe identification parameter is further associated with a predetermined action to be performed at a specified waypoint.

Example 5. The method of example 4, where the predetermined action includes dropping a payload by the vehicle.

Example 6. The method of one of examples 1 to 5, where assigning the position identification to each vehicle includes performing an arbitration process.

Example 7. The method of one of examples 1 to 6, where the vehicles in the vehicle swarm are drones.

Example 8. The method of example 7, where the drones are quadcopters.

Example 9. A method of operating a vehicle within a vehicle swarm, the method including: receiving a sortie specification, the sortie specification specifying a desired behavior the vehicle swarm is to perform; obtaining a position identification within the vehicle swarm; and calculating a set of waypoints based on the received sortie specification and the position identification.

Example 10. The method of example 9, further including: traversing the calculated set of waypoints.

Example 11. The method of one of examples 9 or 10, where the sortie specification includes a recipe identification parameter associated with a predefined route sequence.

Example 12. The method of one of examples 9 to 11, where the recipe identification parameter is further associated with a predetermined action to be performed at a specified waypoint.

Example 13. The method of example 12, where the action includes the vehicle dropping a payload.

Example 14. The method of one of examples 9 to 13, where obtaining the position identification includes participating in an arbitration process.

Example 15. The method of example 14, where participating in the arbitration process includes: counting a number of neighboring vehicles; and adding a constant to the counted number to determine the position identification.

Example 16. The method of one of examples 1 to 15, where the sortie specification includes a velocity, an altitude, a spacing or a descent angle.

Example 17. The method of one of examples 9 to 16, where the vehicle is a drone.

Example 18. The method of example 17, where the drone is a quadcopter.

Example 19. A system configured to be coupled to a vehicle within a vehicle swarm, the system including: a processor; and a memory coupled to the processor with instructions stored thereon, where the instructions, when executed by the processor, enable the processor to perform the following steps: receiving a sortie specification, the sortie specification specifying a desired behavior the vehicle swarm is to perform, obtaining a position identification within the vehicle swarm, and calculating a set of waypoints based on the received sortie specification and the position identification.

Example 20. The system of example 19, where the instructions, when executed by the processor, further enable the processor to instruct the vehicle to traverse the calculated set of waypoints.

Example 21. The system of one of examples 19 or 20, where the system is a dongle configured to be coupled to an autopilot system of the vehicle.

Example 22. The system of one of examples 19 to 21, further including an RF communication system configured to communicate with a further vehicle and with a system controller.

Example 23. The system of one of examples 19 to 21, wherein the vehicle is a drone.

Example 24. The system of example 23, wherein the drone is a quadcopter.

Example 25. A method of controlling a vehicle swarm, including: receiving, from a user interface, a swarm request specifying a desired behavior for the vehicle swarm to perform; encoding the swarm request into a data structure specific to the desired behavior; loading the encoded data structure into a designated portion of a packet; and transmitting, via a radio, the packet including the encoded data structure to a plurality of vehicles in the vehicle swarm to enable each vehicle to calculate a set of waypoints based on the swarm request and a position identification assigned to each vehicle.

Example 26. The method of example 25, where the method is performed by a bridge in communication with the user interface.

Example 27. The method of one of examples 25 or 26, where the user interface includes a tablet in communication with the bridge.

Example 28. The method of one of examples 25 to 27, where receiving the swarm request includes receiving the swarm request via a web service running on the bridge.

Example 29. The method of example 28, where the web service provides a Representational State Transfer (RESTful) interface for the user interface to interact with the vehicle swarm.

Example 30. The method of one of examples 25 to 29, where the encoded data structure includes a recipe identification parameter that specifies a predefined algorithm for each vehicle to use to calculate the set of waypoints.

Example 31. The method of example 30, where the predefined algorithm determines a shape of a formation for the vehicle swarm, routes for the vehicles to take to one or more destinations, and actions for the vehicles to perform.

Example 32. The method of one of examples 25 to 30, where the position identification assigned to each vehicle is used by each vehicle to determine a unique position in a formation relative to other vehicles in the vehicle swarm.

Example 33. The method of one of examples 25 to 32, where the encoded data structure further includes a target, a pattern bearing; a velocity, an altitude, a spacing between vehicles, a staging distance, or a number of vehicles in the swarm.

Example 34. The method of one of examples 25 to 33, further including determining the position identification for each vehicle by performing an arbitration process.

Example 35. A non-transitory computer readable medium with instructions stored thereon, where the instructions, when executed by a processor, enable the processor to perform: receiving a sortie specification specifying a desired behavior the vehicle swarm is to perform; obtaining a position identification of a vehicle within a vehicle swarm; and calculating a set of waypoints based on the received sortie specification and the position identification.

Example 36. The non-transitory computer readable medium of example 35, where the instructions, when executed by the processor, further enable the processor to cause the vehicle to traverse the calculated set of waypoints.

Example 37. The non-transitory computer readable medium of one of examples 35 or 36, where the sortie specification includes a recipe identification parameter associated with a predefined route sequence.

Example 38. The non-transitory computer readable medium of example 37, where the recipe identification parameter is further associated with a predetermined action to be performed at a specified waypoint.

Example 39. The non-transitory computer readable medium of example 38, where the action includes the vehicle dropping a payload.

Example 40. The non-transitory computer readable medium of one of examples 35 to 39, where obtaining the position identification includes participating in an arbitration process.

Example 41. The non-transitory computer readable medium of example 40, where participating in the arbitration process includes: counting a number of neighboring vehicles; and adding a constant to the counted number to determine the position identification.

Example 42. The non-transitory computer readable medium of one of examples 35 to 41, where the sortie specification includes a velocity, an altitude, a spacing, or a descent angle.

Example 43. A method for initiating swarm behavior including: receiving a sortie specification by a group of vehicles in a vehicle swarm, the sortie specification specifying a desired behavior for the vehicle swarm to perform; the vehicles arbitrating among themselves to assign a position identification to each vehicle of the group of vehicles in the vehicle swarm; and each vehicle self-determining its subsequent behavior based on the received sortie specification and its assigned position identification.

Example 44. The method of example 43, where each vehicle self-determining its subsequent behavior includes each vehicle calculating a set of waypoints and associated actions based on the sortie specification and the assigned position identification.

Example 45. The method of one of examples 43 or 44, where each vehicle self-determining its subsequent behavior includes each vehicle executing an onboard swarm algorithm based on the sortie specification and the assigned position identification.

Example 46. The method of one of examples 43 to 45, where the arbitrating creates an ordered list of vehicles.

Example 47. The method of example 46, where the ordered list is based on existing vehicle identifications.

Example 48. The method of example 46, where the ordered list is based on distance from a geographic point.

Example 49. The method of example 46, where the ordered list is based on distance from a particular vehicle of the group of vehicles of the vehicle swarm.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of operating a vehicle within a vehicle swarm, the method comprising:
receiving a sortie specification, the sortie specification specifying a desired behavior the vehicle swarm is to perform;
obtaining a position identification within the vehicle swarm; and
calculating a set of waypoints based on the received sortie specification and the position identification.

2. The method of claim 1, further comprising: traversing the calculated set of waypoints.

3. The method of claim 1, wherein the sortie specification comprises a recipe identification parameter associated with a predefined route sequence.

4. The method of claim 3, wherein the recipe identification parameter is further associated with a predetermined action to be performed at a specified waypoint.

5. The method of claim 4, wherein the action comprises the vehicle dropping a payload.

6. The method of claim 1, wherein obtaining the position identification comprises participating in an arbitration process.

7. The method of claim 6, wherein participating in the arbitration process comprises:
counting a number of neighboring vehicles; and
adding a constant to the counted number to determine the position identification.

8. The method of claim 1, wherein the sortie specification includes a velocity, an altitude, a spacing or a descent angle.

9. A system configured to be coupled to a vehicle within a vehicle swarm, the system comprising:
a processor; and
a memory coupled to the processor with instructions stored thereon, wherein the instructions, when executed by the processor, enable the processor to perform the following steps:
receiving a sortie specification, the sortie specification specifying a desired behavior the vehicle swarm is to perform,
obtaining a position identification within the vehicle swarm, and
calculating a set of waypoints based on the received sortie specification and the position identification.

10. The system of claim 9, wherein the instructions, when executed by the processor, further enable the processor to instruct the vehicle to traverse the calculated set of waypoints.

11. The system of claim 9, wherein the system is a dongle configured to be coupled to an autopilot system of the vehicle.

12. The system of claim 11, further comprising an RF communication system configured to communicate with a further vehicle and with a system controller.

13. The system of claim 9, wherein the vehicle is a drone.

14. The system of claim 13, wherein the drone is a quadcopter.

15. A method of controlling a vehicle swarm, comprising:
receiving, from a user interface, a swarm request specifying a desired behavior for the vehicle swarm to perform;
encoding the swarm request into a data structure specific to the desired behavior;
loading the encoded data structure into a designated portion of a packet; and
transmitting, via a radio, the packet including the encoded data structure to a plurality of vehicles in the vehicle swarm to enable each vehicle to calculate a set of waypoints based on the swarm request and a position identification assigned to each vehicle.

16. The method of claim 15, wherein the method is performed by a bridge in communication with the user interface.

17. The method of claim 16, wherein the user interface comprises a tablet in communication with the bridge.

18. The method of claim 16, wherein receiving the swarm request comprises receiving the swarm request via a web service running on the bridge.

19. The method of claim 18, wherein the web service provides a Representational State Transfer (RESTful) interface for the user interface to interact with the vehicle swarm.

20. The method of claim 15, wherein the encoded data structure includes a recipe identification parameter that specifies a predefined algorithm for each vehicle to use to calculate the set of waypoints.

21. The method of claim 20, wherein the predefined algorithm determines a shape of a formation for the vehicle swarm, routes for the vehicles to take to one or more destinations, and actions for the vehicles to perform.

22. The method of claim 15, wherein the position identification assigned to each vehicle is used by each vehicle to determine a unique position in a formation relative to other vehicles in the vehicle swarm.

23. The method of claim 15, wherein the encoded data structure further includes a target, a pattern bearing; a velocity, an altitude, a spacing between vehicles, a staging distance, or a number of vehicles in the swarm.

24. The method of claim 15, further comprising determining the position identification for each vehicle by performing an arbitration process.
